(19) United States
(12) Patent Application Publication
(10) Pub. No.: US 2020/0089332 A1
(43) Pub. Date: Mar. 19, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Nobuyuki YAMAZOE, Kanagawa (JP)

(73) Assignee: FUJI XEROX CO., LTD., TOKYO (JP)

(21) Appl. No.: 16/559,653

(22) Filed: Sep. 4, 2019

(30) Foreign Application Priority Data
Sep. 13, 2018 (JP) 2018-171313

(51) Int. Cl. G06F 3/03; G06F 3/14; G06K 9/34

(52) U.S. Cl. CPC G06F 3/0317; G06K 2209/01; G06K 9/344; G06F 3/1454

(57) ABSTRACT

An information processing apparatus includes a display controller and a determining unit. The display controller performs control to display a board and a sticky note on a horizontal screen. The determining unit determines a position of a sticky note to be placed on the board in accordance with a position of a user or an operation performed by the user. The display controller performs control to display a sticky note received from a terminal of the user at the position determined by the determining unit.

### CROSS-REFERENCE TO RELATED APPLICATIONS

This application is based on and claims priority under 35 USC 119 from Japanese Patent Application No. 2018-171313 filed Sep. 13, 2018.

### BACKGROUND

### (i) Technical Field

The present disclosure relates to an information processing apparatus and a non-transitory computer readable medium.

### (ii) Related Art

Japanese Patent No. 6056648 discloses an information processing apparatus including first and second receivers and a creator. The first receiver receives at least first sticky note information from a first terminal. A second terminal receives an operation for adding sticky note information to a board. The second receiver receives an operation for enabling a work area for adding the first sticky note information from the second terminal. If the second receiver has received an operation for enabling a work area, the creator creates display information for displaying in the work area an image indicating that the first sticky note information has been added. If the second receiver has received an operation for enabling a work area, the creator creates display information for displaying in the work area an image indicating feature information concerning the board or the relationship between the first sticky note information and second sticky note information which has already been added to the board.

Japanese Patent No. 5974976 discloses an information processing apparatus including an obtaining unit, an extractor, and a sender. The obtaining unit obtains position information indicating a position of a user. The extractor extracts, from among items of sticky note information displayed on a shared screen, sticky note information created by a user near the shared screen, based on the position information obtained by the obtaining unit. The sender sends the sticky note information extracted by the extractor to user terminals, as sticky note information to be displayed for relating items of sticky note information created by users with each other on the user terminals.

### SUMMARY

In a meeting, users may add sticky notes to a paper board while having a discussion. In a digital sticky-note system, a digital board is displayed on a large screen and digital sticky notes are added to the digital board. Typically, the screen is vertically placed on the floor. This usually requires a facilitator to take charge of adding sticky notes to the board all by itself. The screen may alternatively be placed horizontally on the floor. In this case, instead of a facilitator controlling the adding of sticky notes, users may wish to individually place a sticky note at a desired position on the board where they can easily give an explanation about the sticky note.

Aspects of non-limiting embodiments of the present disclosure relate to an information processing apparatus and a non-transitory computer readable medium that allow individual users participating in a meeting, for example, using a horizontal screen which displays a board and sticky notes, to place a sticky note at a position on the board where they can easily give an explanation about the sticky note, unlike a case in which a facilitator takes charge of adding sticky notes to the board all by itself.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a display controller and a determining unit. The display controller performs control to display a board and a sticky note on a horizontal screen. The determining unit determines a position of a sticky note to be placed on the board in accordance with a position of a user or an operation performed by the user. The display controller performs control to display a sticky note received from a terminal of the user at the position determined by the determining unit.

### BRIEF DESCRIPTION OF THE DRAWINGS

An exemplary embodiment of the present disclosure will be described in detail based on the following figures, wherein:

FIG. 1 is a block diagram illustrating conceptual modules forming an example of the configuration of the exemplary embodiment;

FIGS. 2A and 2B illustrate examples of the system configuration utilizing the exemplary embodiment;

FIG. 3 illustrates an example of the system configuration utilizing the exemplary embodiment;

FIGS. 4A through 4C illustrate examples of the use of a shared terminal and user terminals in a meeting room, for example, according to the exemplary embodiment;

FIG. 5 illustrates an example of the data structure of a terminal-user management table;

FIG. 6 illustrates an example of the data structure of a user management table;

FIG. 7 illustrates an example of the data structure of a user position management table;

FIG. 8 illustrates an example of the data structure of a board information table;

FIG. 9 illustrates an example of the data structure of a sticky-note information table;

FIG. 10 is a flowchart illustrating an example of processing executed by the exemplary embodiment;

FIG. 11 illustrates examples of the sides of a shared screen;

FIG. 12 is a flowchart illustrating an example of processing executed by the exemplary embodiment;

FIG. 13 is a flowchart illustrating an example of processing executed by the exemplary embodiment;

FIG. 14 is a flowchart illustrating an example of processing executed by the exemplary embodiment;

FIG. 15 illustrates an example of processing executed by the exemplary embodiment;

FIG. 16 illustrates an example of processing executed by the exemplary embodiment;

FIG. 17 illustrates an example of processing executed by the exemplary embodiment;

FIG. 18 illustrates an example of processing executed by the exemplary embodiment;

FIG. 19 illustrates an example of processing executed by the exemplary embodiment;

FIG. 20 illustrates an example of processing executed by the exemplary embodiment;

FIG. 21 illustrates an example of processing executed by the exemplary embodiment;

FIG. 22 illustrates an example of processing executed by the exemplary embodiment;

FIG. 23 illustrates an example of processing executed by the exemplary embodiment;

FIG. 24 illustrates an example of processing executed by the exemplary embodiment;

FIG. 25 illustrates an example of processing executed by the exemplary embodiment; and

FIG. 26 is a block diagram illustrating an example of the hardware configuration of a computer implementing the exemplary embodiment.

### DETAILED DESCRIPTION

An exemplary embodiment of the disclosure will be described below with reference to the accompanying drawings.

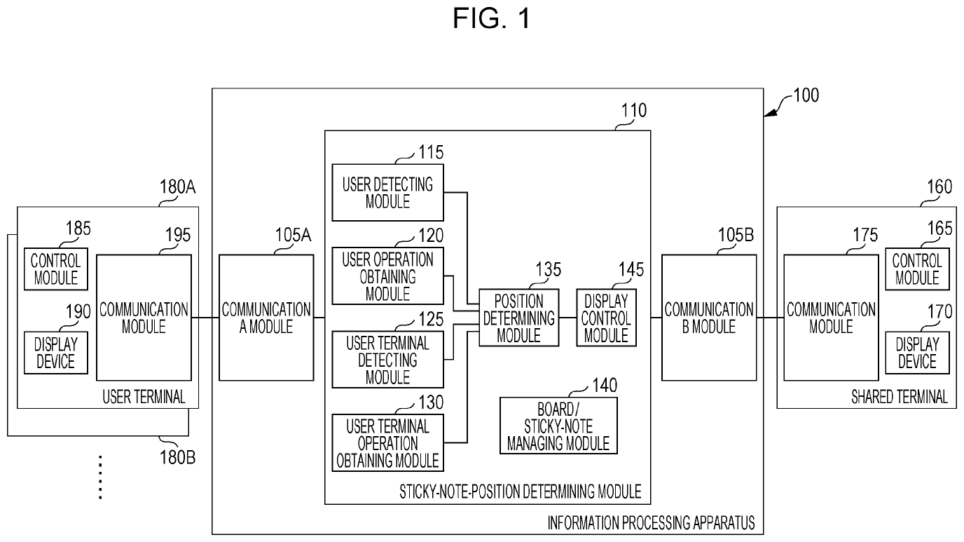

FIG. 1 is a block diagram illustrating conceptual modules forming an example of the configuration of the exemplary embodiment.

Generally, modules are software (computer programs) components or hardware components that can be logically separated from one another. The modules of the exemplary embodiment of the disclosure are, not only modules of a computer program, but also modules of a hardware configuration. Thus, the exemplary embodiment will also be described in the form of a computer program for allowing a computer to function as those modules (a program for causing a computer to execute program steps, a program for allowing a computer to function as corresponding units, or a computer program for allowing a computer to implement corresponding functions), a system, and a method. While expressions such as “store”, “storing”, “being stored”, and equivalents thereof are used for the sake of description, such expressions indicate, when the exemplary embodiment relates to a computer program, storing the computer program in a storage device or performing control so that the computer program will be stored in a storage device. Modules may correspond to functions based on a one-to-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationships among data elements, login, etc.). The term “predetermined” means being determined prior to a certain operation, and includes the meaning of being determined prior to a certain operation before starting processing of the exemplary embodiment, and also includes the meaning of being determined prior to a certain operation even after starting processing of the exemplary embodiment, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is unnecessary. If elements are enumerated, such as “A, B, and C”, they are only examples unless otherwise stated, and such enumeration includes the meaning that only one of them (only the element A, for example) is selected.

A system or an apparatus may be implemented by connecting plural computers, hardware units, devices, etc., to one another via a communication medium, such as a network (including communication connection based on a one-to-one correspondence), or may be implemented by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processing result is written into the storage device. A description of reading from the storage device before an operation or writing into the storage device after an operation may be omitted. Examples of the storage device may be a hard disk, a random access memory (RAM), an external storage medium, a storage device using a communication line, and a register within a central processing unit (CPU).

An information processing apparatus 100 according to the exemplary embodiment executes processing concerning a board and sticky notes (also called digital sticky notes or digital cards) used in a meeting. As shown in the example in FIG. 1, the information processing apparatus 100 includes a communication A module 105A, a communication B module 105B, and a sticky-note-position determining module 110.

A meeting may be any type of meeting where people get together to discuss, and may be a business meeting, a workshop, a brainstorming session, a study meeting, a seminar, a discussion meeting, or an assembly meeting. The exemplary embodiment concerns a digital sticky-note system (also called a digital whiteboard) using a digital board and digital sticky notes.

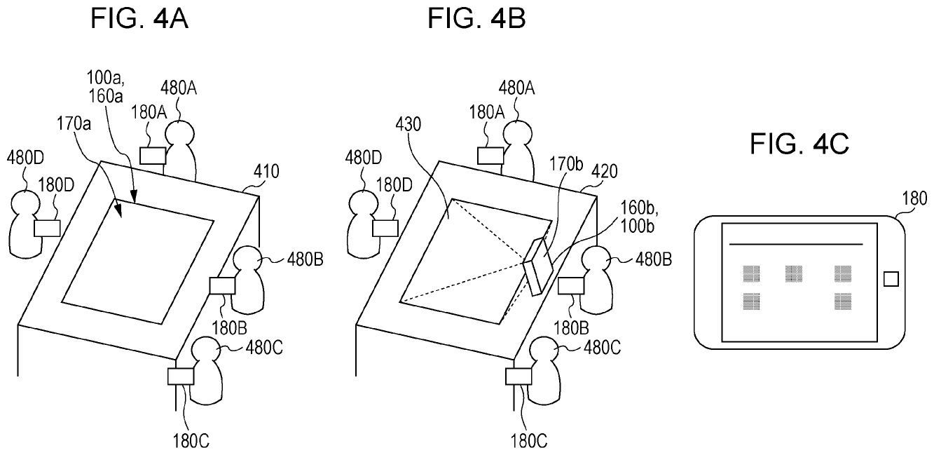

As shown in FIGS. 4A through 4C, the digital sticky-note system is used in a meeting in which plural users participate (hereinafter simply called users). The users each hold a user terminal 180 and get around a display device 170a or a screen 430 displaying a board and add sticky notes to the board. The board is displayed on a horizontal screen, such as a liquid crystal display of the display device 170a or the screen 430 displayed by a display device 170b, so that all the users can equally operate the board. If the board is displayed on a vertical screen as in the related art, only a limited number of people can operate the board. Usually, the use of a vertical screen assumes that a facilitator operates the board (shared screen). The facilitator takes charge of operating the board all by itself, such as adding sticky notes sent from the users to the board and moving the sticky notes on the board. If the board is displayed on a horizontal screen, however, all the users can equally operate the board as stated above, and a facilitator dedicated to operating the board is not necessary. The users can be close to the board and move around the board as they like and do not stay at the same position. This enables the users to place a sticky note at a position on the board where they can easily give an explanation about the sticky note. However, the purpose of use of a horizontal screen in a meeting does not exclude the provision of a facilitator, but allows all the users including a facilitator in the meeting to operate the board.

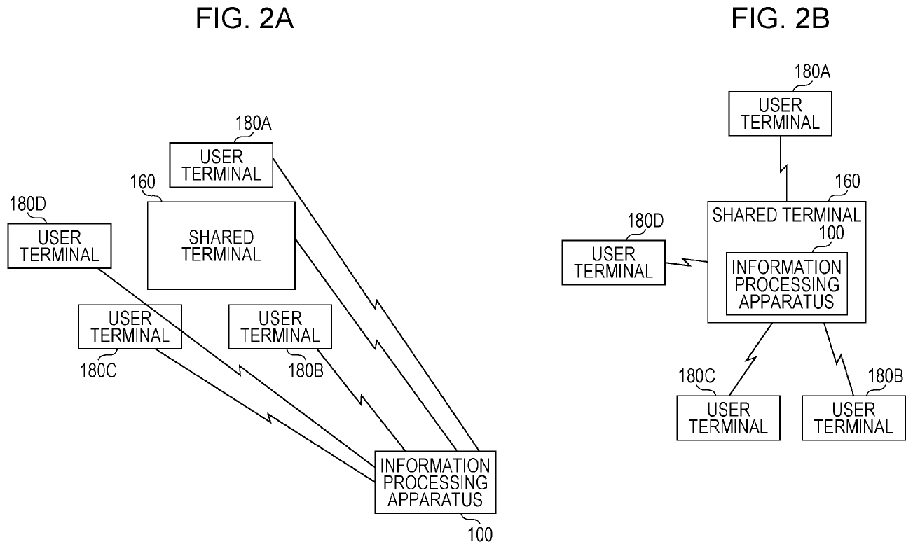

Typically, as shown in the examples in FIGS. 2A and 2B, the system configuration used in a meeting includes one shared terminal 160 and plural user terminals 180A through 180D (hereinafter simply called a user terminal 180, the user terminal 180, or user terminals 180 unless it is necessary to distinguish them from each other) used by users participating in the meeting. The information processing apparatus 100 receives information concerning a sticky note from a user terminal 180 and adds it to the board. The users operate the board displayed on a horizontal screen to determine or change (move) the positions of sticky notes on the board, link some sticky notes together (linking first and second sticky notes with each other, for example, which is also called group forming), and edit (delete or modify) sticky notes. The users can proceed with the meeting in this manner.

Referring back to FIG. 1, the communication A module 105A is connected to the sticky-note-position determining module 110 and a communication module 195 of each user terminal 180. The communication A module 105A communicates with the user terminals 180 and receives information concerning sticky notes, positions of the user terminals 180, and operations performed on the user terminals 180 from the user terminals 180. The communication A module 105A also sends information concerning the board and sticky notes added to the board to the user terminals 180.

The communication B module 105B is connected to the sticky-note-position determining module 110 and a communication module 175 of the shared terminal 160. The communication B module 105B communicates with the shared terminal 160 and receives information concerning operations performed on the board displayed on the shared terminal 160. The communication B module 105B also sends information concerning the board and sticky notes to be added to the board to the shared terminal 160.

The sticky-note-position determining module 110 includes a user detecting module 115, a user operation obtaining module 120, a user terminal detecting module 125, a user terminal operation obtaining module 130, a position determining module 135, a board/sticky-note managing module 140, and a display control module 145. The sticky-note-position determining module 110 is connected to the communication A module 105A and the communication B module 105B. The sticky-note-position determining module 110 manages the board and sticky notes and executes processing, such as determining the positions of sticky notes to be placed on the board.

The board/sticky-note managing module 140 manages information concerning the board and sticky notes. For example, the board/sticky-note managing module 140 stores a board information table 800 and a sticky-note information table 900, which will be discussed later, and generates a board, adds sticky notes to the board, and performs editing operations, such as moving, copying, and deleting sticky notes.

The display control module 145 is connected to the position determining module 135. The display control module 145 performs control so that the shared terminal 160 displays the board and sticky notes on the horizontal screen.

The horizontal screen may not necessarily be exactly horizontal and may be somewhat inclined with respect to the horizontal direction. That is, the horizontal screen may be inclined if it allows users to get together around the horizontal screen. For example, the horizontal screen may be a display device, such as a liquid crystal display, built in a table (display-built-in table) or a table having a horizontal surface on which an image is projected by a projector.

The display control module 145 performs control to display a sticky note received from a user terminal 180 at a position determined by the position determining module 135.

The display control module 145 may display a provisional sticky note, which is a drawing (icon) without the content of a sticky note, at a position determined by the position determining module 135, and shift the provisional sticky note on the board in accordance with the movement of a user. Such a provisional sticky note has been created in the user terminal 180, but has not been added to the board (in other words, the user has not performed an operation for adding the sticky note to the board). The display control module 145 displays such a provisional sticky note in accordance with the movement of the user.

The display control module 145 displays a provisional sticky note at a position determined by the position determining module 135 and does not accept any operation for moving this provisional sticky note on the board. That is, since a provisional sticky note is not a fixed sticky note, the display control module 145 prohibits the owner user of the provisional sticky note and other users from moving the provisional sticky note on the board. When the owner user has performed an operation for adding the sticky note to the board by using the user terminal 180, the display control module 145 converts the provisional sticky note into a fixed sticky note. More specifically, the display control module 145 adds the content of the sticky note to the provisional sticky note. Thereafter, the display control module 145 accepts an operation for moving this sticky note on the board from all the users (owner user and other users). That is, this sticky note is handled as a regular sticky note.

The position determining module 135 is connected to the user detecting module 115, the user operation obtaining module 120, the user terminal detecting module 125, the user terminal operation obtaining module 130, and the display control module 145. The position determining module 135 receives a result of detecting a user from the user detecting module 115, a result of detecting a user operation performed on the board from the user operation obtaining module 120, a result of detecting a user terminal 180 from the user terminal detecting module 125, and a result of detecting an operation performed on the user terminal 180 from the user terminal operation obtaining module 130 so as to determine the position of a sticky note to be placed on the board by using these results. “Position of a sticky note to be placed on the board” is a position of a sticky note to be placed on the board after it is created in the user terminal 180.

The position determining module 135 determines the position of a sticky note to be placed on the board in accordance with the position or the operation performed by a user (user terminal 180).

The position determining module 135 may detect the position of the user terminal 180 and determine the position of a sticky note to be placed on the board in accordance with the detected position of the user terminal 180.

To detect the position of the user terminal 180, the position determining module 135 may communicate with the user terminal 180 and obtain the position and the orientation, for example, of the user terminal 180.

The position of a sticky note to be placed on the board may be a position near one of the sides of the board close to the position of the user terminal 180, or may be a position on the board closest to the position of the user terminal 180.

The position determining module 135 may also detect the position of the body or part of the body of a user and may determine the position of a sticky note to be placed on the board in accordance with the position of the body or part of the body and the position of the user terminal 180.

Part of the body may be a hand (including a finger). The body or part of the body may be detected by an infrared sensor or a camera, for example. In particular, the position of a user moving its hand may be detected.

If the position of the body or part of the body (hereinafter simply called the body) and the position of the user terminal 180 are the same position, the position determining module 135 may use this position to determine the position of a sticky note to be placed on the board. If the position of the body and the position of the user terminal 180 are different, such as if one of the position of the body and that of the user terminal is on one side of the board and the other one of the positions is on another side of the board, one of the positions may preferentially be used or the average value of the two positions may be used. Alternatively, the priority levels may be assigned to the two positions (for example, 70% for the position of the user terminal and 30% for the position of the user), and a suitable position may be determined according to the ratio of the priority levels.

The position determining module 135 may determine the position of a sticky note to be placed on the board in accordance with an operation performed by a user on the board.

The operation performed by the user may be writing the name of this user in longhand on the board.

In this case, the position determining module 135 may perform character recognition to recognize the written name and determine the position of a sticky note to be placed on the board in accordance with the recognized name.

The board/sticky-note managing module 140 may display a list of user names on the board and allow a user to select a user name.

The above-described operation performed by the user may be selecting the name of the user from the list.

In this case, the position determining module 135 may determine the position of a sticky note to be placed on the board in accordance with the selected name.

The position determining module 135 may determine the position of a sticky note to be placed on the board in accordance with an operation performed by the user on the user terminal 180.

The operation performed by the user may be an operation when sending a sticky note from the user terminal 180. The position determining module 135 may determine the position of a sticky note to be placed on the board in accordance with this sending operation.

The operation performed by the user may be an operation on the board displayed on the user terminal 180. The position determining module 135 may determine the position of a sticky note to be placed on the board in accordance with the operation on the board.

The user detecting module 115 is connected to the position determining module 135. The user detecting module 115 detects the position of the body or part of the body of a user participating in a meeting (user around the shared screen). More specifically, the user detecting module 115 may communicate with the user terminal 180 and detect the owner user of the user terminal 180. The user detecting module 115 may alternatively detect the user by using a camera or a sensor (human sensor such as an infrared sensor or an ultrasonic sensor).

The user operation obtaining module 120 is connected to the position determining module 135. The user operation obtaining module 120 obtains an operation performed by a user on the board, such as writing characters in longhand on the board and selecting the name of this user from a list of user names displayed on the board.

The user terminal detecting module 125 is connected to the position determining module 135. The user terminal detecting module 125 detects the position of the user terminal 180 of a user.

The user terminal operation obtaining module 130 is connected to the position determining module 135. The user terminal operation obtaining module 130 obtains an operation performed by the user on the user terminal 180, such as selecting the position of a sticky note to be placed on the board and adding the sticky note to the board. Selecting the position of a sticky note and adding the sticky note to the board may be performed by one operation.

The shared terminal 160 includes a control module 165, a display device 170, and the communication module 175. The shared terminal 160 displays a board and sticky notes added to the board on the shared screen, which is a horizontal screen, under the control of the information processing apparatus 100.

The control module 165 controls the other modules (such as display device 170 and communication module 175) within the shared terminal 160, and detects an operation performed by a user on the board and sends a detection result to the information processing apparatus 100.

The display device 170 receives information indicating the board and sticky notes added to the board from the information processing apparatus 100 and displays the board and sticky notes on the display (horizontal screen) of the shared terminal 160.

The communication module 175 is connected to the communication B module 105B of the information processing apparatus 100 and communicates with the information processing apparatus 100.

The user terminal 180 includes a control module 185, a display device 190, and the communication module 195. The user terminal 180 is owned by a user participating in a meeting. Typically, the user creates a sticky note by using the user terminal 180. The user terminal 180 communicates with the information processing apparatus 100.

The control module 185 controls the other modules (such as display device 190 and communication module 195) within the user terminal 180, and detects an operation performed by the user on the user terminal 180 and sends a detection result to the information processing apparatus 100.

The display device 190 displays a screen for creating a sticky note. The display device 190 also receives information indicating the board and sticky notes added to the board from the information processing apparatus 100 and displays the board and sticky notes on the display of the user terminal 180.

The communication module 195 is connected to the communication A module 105A of the information processing apparatus 100 and communicates with the information processing apparatus 100.

FIGS. 2A and 2B illustrate examples of the system configuration utilizing the exemplary embodiment.

In the example in FIG. 2A, the information processing apparatus 100 is disposed separately from the shared terminal 160.

The information processing apparatus 100 is connected to the shared terminal 160 and the user terminals 180A through 180D via a communication line. In the exemplary embodiment, the communication line may be a wireless or wired medium, or a combination thereof, and near field communication (NFC) such as Wi-Fi or Bluetooth (registered trademark) is used. The communication line used between the information processing apparatus 100 and the user terminals 180 is desirably a wireless medium because users having the user terminals 180 usually move around the horizontal screen.

In the example in FIG. 2B, the information processing apparatus 100 is integrated within the shared terminal 160.

The shared terminal 160 contains the information processing apparatus 100 and is connected to the user terminals 180A through 180D. In this example, the information processing apparatus 100 and the shared terminal 160 may communicate with each other via an internal bus.

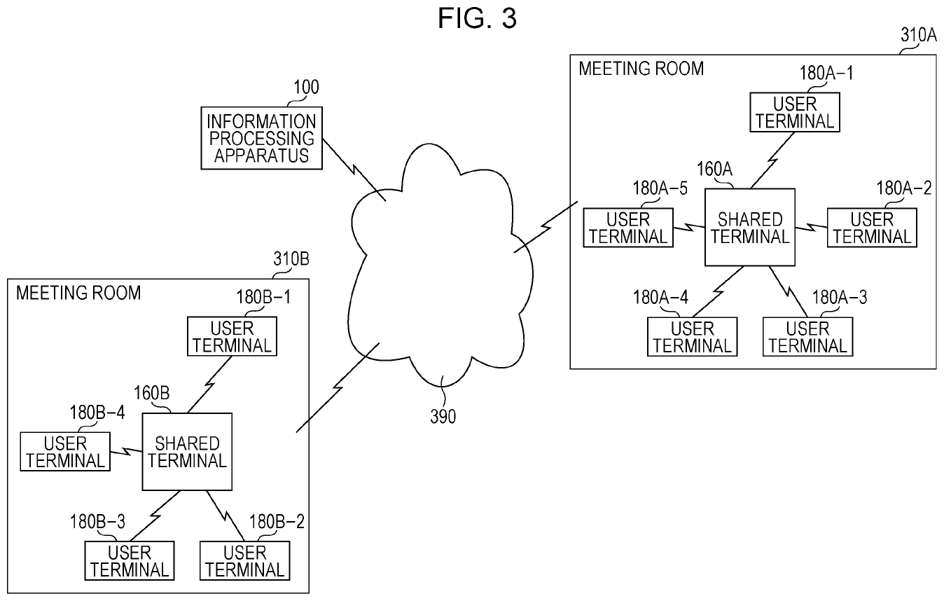

FIG. 3 illustrates an example of the system configuration utilizing the exemplary embodiment.

A meeting is held in each of meeting rooms 310A and 310B.

In the meeting room 310A, a shared terminal 160A and user terminals 180A-1 through 180A-5 are installed. The shared terminal 160A is connected to the user terminals 180A-1 through 180A-5.

In the meeting room 310B, a shared terminal 160B and user terminals 180B-1 through 180B-4 are installed. The shared terminal 160B is connected to the user terminals 180B-1 through 180B-4.

The information processing apparatus 100, the terminals within the meeting room 310A (in particular, the shared terminal 160A), and the terminals within the meeting room 310B (in particular, the shared terminal 160B) are connected to one another via a communication line 390. The communication line 390 may be a wireless or wired medium, or a combination thereof, and may be, for example, the Internet or an intranet as a communication infrastructure. The functions of the information processing apparatus 100 may be implemented as cloud services.

FIGS. 4A through 4C illustrate examples of the use of the shared terminal 160 and user terminals 180 in a meeting room, for example, according to the exemplary embodiment. In the examples in FIGS. 4A through 4C, the information processing apparatus 100 is integrated within the shared terminal 160.

As shown in the examples in FIGS. 4A and 4B, plural users 480A through 480D (hereinafter called a user 480, the user 480, or users 480) get together in a meeting room, for example. The users 480 are participating in a meeting by using the user terminal 180. Usually, one user terminal 180 is assigned to each user 480. As shown in the example in FIG. 4C, the terminal 180 is a tablet terminal of a notebook size (such as the A4 or B5 size, which is about seven to ten inches) and is used with a finger or a pen. The user 480 generates sticky note information indicating text data, handwritten characters, or a drawing, for example. The user terminal 180 is not restricted to a tablet terminal and may be a personal computer (PC) (including a laptop PC) with a keyboard and a mouse.

A display-built-in table 410 shown in FIG. 4A contains an information processing apparatus 100a and a shared terminal 160a. The display device 170a (also called a digital board), such as a liquid crystal display, is built in the upper plate of the display-built-in table 410 so as to form a horizontal screen. The display device 170a usually has a large screen of about 80 inches, for example (at least larger than the display of the user terminal 180), and displays a board and sticky notes. The display device 170a is a touchscreen and detects the position and the pressure of a finger or a pen, for example, touching the screen. Each user 480 operates its own user terminal 180 to create a sticky note and adds it to a board displayed on the display device 170a. The users 480 have a discussion by looking at sticky notes added to the board.

A display device 170b of a shared terminal 160b shown in the example in FIG. 4B is a projector installed on a table 420. The upper plate of the table 420 is also used as the screen 430. On the screen 430, images (board and sticky notes) projected by the display device 170b are displayed. The display device 170b has the function of making keystone correction on images projected on the screen 430, which is the projecting surface. Instead of installing the display device 170b on the table 420, it may be fixed on the ceiling above the table 420.

The screen 430, which also serves as a digital whiteboard, detects the movement of a finger or a pen of a user 480 so as to receive an operation for adding or moving a sticky note. For example, a pen is kept in a predetermined pen holder on the table 420. The screen 430 detects that the pen is removed from the pen holder, that is, the user 480 has lifted the pen, and that the pen tip has touched the screen 430 (the position of the pen tip on the screen 430) so as to receive an operation performed by the user 480 on a board or a sticky note. For example, plural pens (such as black, red, and blue pens) are kept in the pen holder, and a sensor, which is turned ON and OFF in accordance with the gravity of a pen, is integrated in the pen holder. The screen 430 detects which one of the plural pens is being used. The screen 430 is a touch sensor and detects the position and the pressure of a pen touching the display screen. In this example, the pen is turned ON and OFF under the control of the pen holder. However, the provision of the pen holder may be omitted, in which case, the pen may be ON and OFF by itself. In this example, plural pens having different colors are kept in the pen holder. However, only a single pen may be provided and the color of the pen may be changed as follows. A color palette is provided on part of the display screen, and the pen (or an object similar to a pen) touches a desired color so as to change the color of the pen. Alternatively, the pen may be provided with a function (such as a button or a slider) of giving an instruction to change the color.

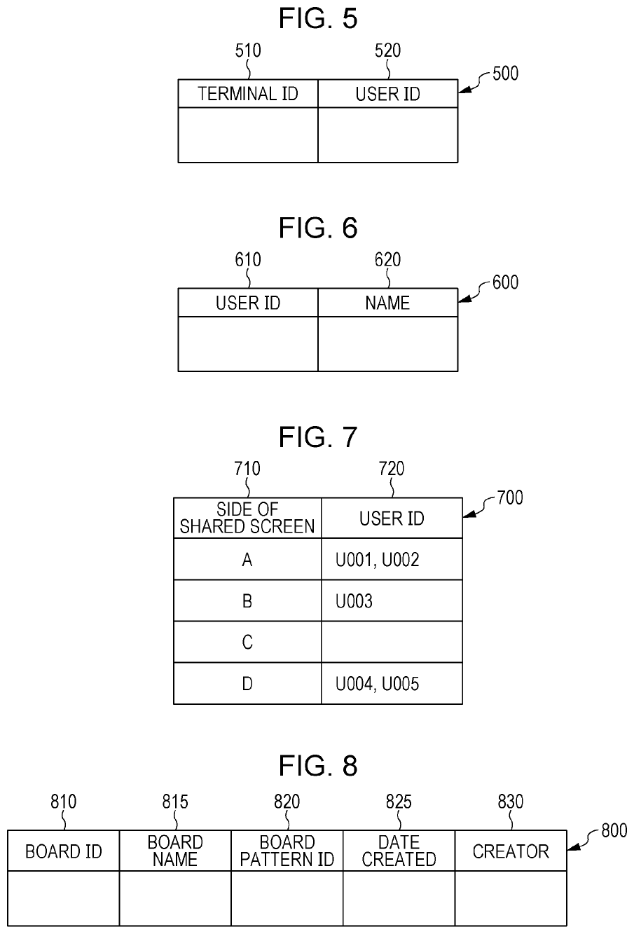

The position determining module 135 may have a terminal-user management table 500 and identify a user 480 from a terminal ID. FIG. 5 illustrates an example of the data structure of the terminal-user management table 500. The terminal-user management table 500 has a terminal ID field 510 and a user ID field 520. The terminal ID field 510 stores information (terminal ID) for uniquely identifying the user terminal 180 in the exemplary embodiment. The user ID field 520 stores information (user ID) for uniquely identifying the user 480 of this user terminal 180 in the exemplary embodiment.

The position determining module 135 may detect the terminal ID of the user terminal 180 by communicating with the user terminal 180, and may also detect the user associated with the terminal ID by using the terminal-user management table 500.

The position determining module 135 may have a user management table 600 and identify the name of a user 480 from the user ID. FIG. 6 illustrates an example of the data structure of the user management table 600. The user management table 600 has a user ID field 610 and a name field 620. The user ID field 610 stores the user ID. The name field 620 stores the name of the user having this user ID.

The position determining module 135 may detect the user ID by using the terminal-user management table 500, and may also detect the name of the user from the user ID by using the user management table 600.

The position determining module 135 may have a user position management table 700 and manage the position of users. FIG. 7 illustrates an example of the data structure of the user position management table 700. The user position management table 700 has a shared-screen side field 710 and a user ID field 720. The shared-screen side field 710 indicates the side of the shared screen. The user ID field 720 stores the user ID of a user being near this side of the shared screen.

The position determining module 135 detects the user ID by using the terminal-user management table 500, and associates the user ID with the position of the user terminal 180 of the user (the side of the shared screen close to the user terminal 180) so as to generate the user position management table 700. Then, in response to an instruction to add a sticky note from the user terminal 180, the position determining module 135 sets an area near the side of the shared screen corresponding to the user ID to be the position of the sticky note to be placed on the board, based on the user position management table 700.

The board/sticky-note managing module 140 has a board information table 800 and manages the board. FIG. 8 illustrates an example of the data structure of the board information table 800. The board information table 800 has a board ID field 810, a board name field 815, a board pattern ID field 820, a created date field 825, and a creator field 830. The board ID field 810 stores information (board ID) for uniquely identifying the board in the exemplary embodiment. The board name field 815 stores the name of the board having this board ID. The board pattern ID field 820 stores the board pattern ID of the board pattern of this board used as a background. Examples of the board patterns are a blank pattern, a tabular form pattern, and a pattern including reserved areas where sticky notes for describing legends are placed. The created date field 825 indicates the time and date (year, month, day, hour, minute, second, millisecond, or a combination thereof) at and on which the board is created. The creator field 830 indicates the creator of the board.

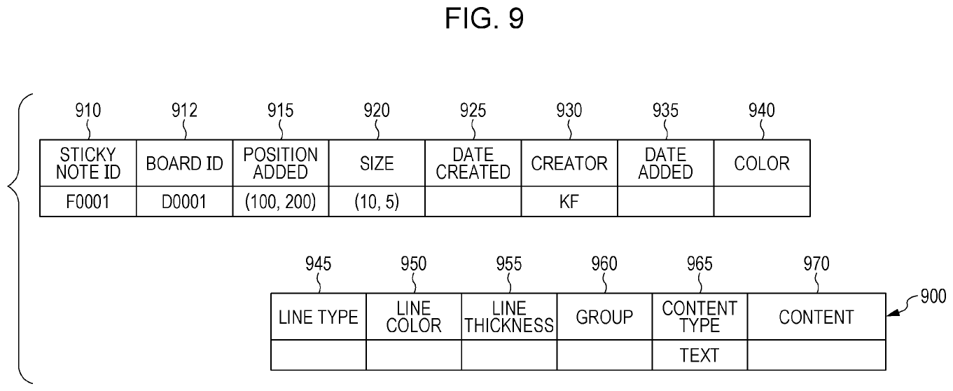

The board/sticky-note managing module 140 has a sticky-note information table 900 and manages sticky notes. FIG. 9 illustrates an example of the data structure of the sticky-note information table 900. The sticky-note information table 900 has a sticky note ID field 910, a board ID field 912, an added position field 915, a size field 920, a created date field 925, a creator field 930, an added date 935, a color field 940, a line type field 945, a line color field 950, a line thickness field 955, a group field 960, a content type field 965, and a content field 970. The sticky note ID field 910 stores information (sticky note ID) for uniquely identifying a sticky note in the exemplary embodiment. The board ID field 912 stores the board ID of the board to which this sticky note is added. The added position field 915 indicates the position of the sticky note placed on the board, which is represented by the coordinates on the XY coordinate system of the board, for example. The size field 920 indicates the size of the sticky note. If the sticky note is rectangular, for example, the width and the height of the sticky note are indicated as the size. The created date field 925 indicates the time and date at and on which the sticky note is created. The creator field 930 indicates the creator (user ID) of the sticky note. The creator field 930 may alternatively indicate an information processing apparatus (device ID of the user terminal 180 or the information processing apparatus 100) that has created the sticky note. The added date field 935 indicates the time and date at and on which the sticky note is added to the board. The color field 940 indicates the display color of the sticky note. The line type field 945 indicates the line type (such as a solid line, a dotted line, a broken line, a wavy line, and double lines) of the displayed sticky note. The line color field 950 indicates the color of the line of the displayed sticky note. The line thickness field 955 indicates the thickness of the line of the displayed sticky note. The group field 960 stores information concerning a group of the sticky note. The group field 960 may store information indicating whether the sticky note belongs to a group, and if it belongs to a group, the group field 960 may store the group ID of this group or the ID of another sticky note belonging to this group. The content type field 965 indicates the content type of sticky note, such as text information, vector data indicating an object such as handwritten characters or a drawing, voice information, still image information such as a photo, video information, or information indicating a combination thereof. The content field 970 stores the content of the sticky note.

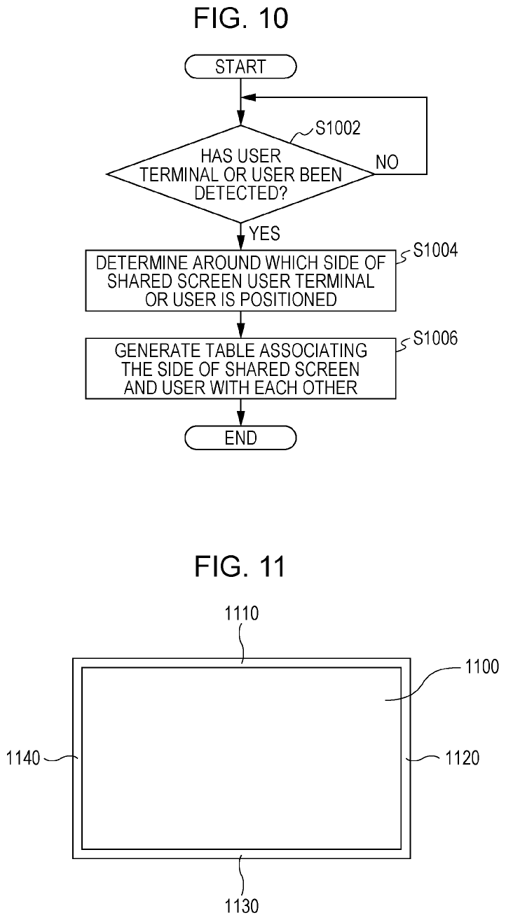

FIG. 10 is a flowchart illustrating an example of processing executed by the exemplary embodiment.

In step S1002, it is judged whether a user terminal 180 or a user 480 has been detected. If a user terminal 180 or a user 480 has been detected, the process proceeds to step S1004. If neither of a user terminal 180 nor a user 480 has been detected, the process waits until a user terminal 180 or a user 480 is detected.

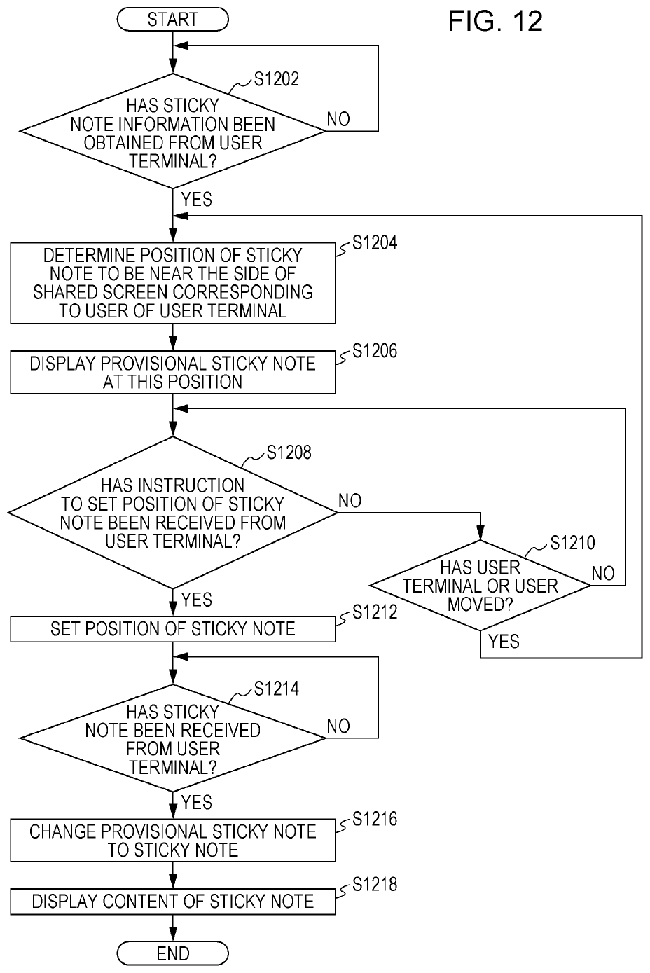

In step S1004, the side of the shared screen around which the detected user terminal 180 or user 480 is positioned is determined. FIG. 11 illustrates examples of the sides of a shared screen 1100. The shared screen 1100 has a top side 1110, a right side 1120, a bottom side 1130, and a left side 1140. The top, bottom, right, and left sides of the shared screen 1100 can be fixed in accordance with the position of a user 480 viewing the shared screen 1100. However, a predetermined side is be set as the top side of the shared screen 1100 and a sticky note is added to the shared screen 1100 so that it can be legible. The top side may be changed in the course of a meeting, that is, the board and sticky notes may be rotated.

In step S1006, the user position management table 700 which associates the side of the shared screen and the user 480 with each other is generated.

Instead of processing in the flowchart of FIG. 10, the user position management table 700 may be generated by processing in the flowchart of FIG. 12, 13, or 14.

FIG. 12 is a flowchart illustrating an example of processing executed by the exemplary embodiment.

In step S1202, it is judged whether sticky note information has been obtained from a user terminal 180. If sticky note information has been obtained, the process proceeds to step S1204. If sticky note information has not been obtained, the process waits until sticky note information is obtained.

In step S1204, the position of the sticky note is determined to be near the side of the shared screen corresponding to the user 480 of the user terminal 180.

In step S1206, a provisional sticky note is displayed at the position determined in step S1204. The provisional sticky note is a drawing (icon) without the content of a sticky note and only suggests the presence of a sticky note. The provisional sticky note may be a simple rectangle or a rectangle with the name of the user therein.

In step S1208, it is judged whether an instruction to set the position of the sticky note has been received from the user terminal 180. If such information has been received, the process proceeds to step S1212. If such information has not been received, the process proceeds to step S1210.

In step S1210, it is judged whether the user terminal 180 or the user 480 has moved. If the user terminal 180 or the user 480 has moved, the process returns to step S1204. If the user terminal 180 or the user 480 has not moved, the process returns to step S1208.

In step S1212, the position of the sticky note is set.

In step S1214, it is judged whether the sticky note has been received from the user terminal 180. If the sticky note has been received, the process proceeds to step S1216. If the sticky note has not been received, the process waits until the sticky note is received.

In step S1216, the provisional sticky note is changed to a sticky note.

In step S1218, the content of the sticky note is displayed.

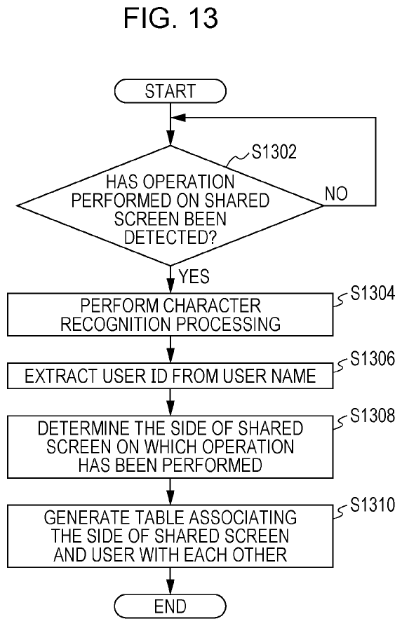

FIG. 13 is a flowchart illustrating an example of processing executed by the exemplary embodiment.

In step S1302, it is judged whether an operation performed on the shared screen has been detected. If any operation has been detected, the process proceeds to step S1304. If no operation has been detected, the process waits until an operation is detected.

If it is found in step S1302, for example, that characters have been written on the shared screen, in step S1304, character recognition processing is performed on the characters (the name of a user in this example) written on the shared screen.

In step S1306, the user ID is extracted from the user name.

In step S1308, the side of the shared screen on which the operation has been performed is determined.

In step S1310, the user position management table 700 which associates the side of the shared screen and the user 480 with each other is generated.

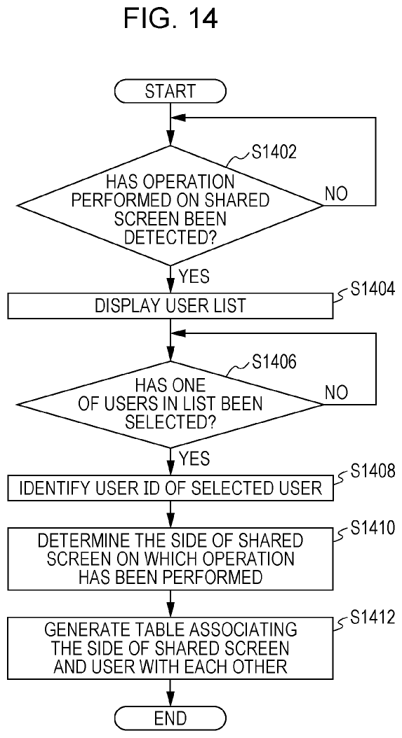

FIG. 14 is a flowchart illustrating an example of processing executed by the exemplary embodiment.

In step S1402, it is judged whether an operation performed on the shared screen has been detected. If any operation has been detected, the process proceeds to step S1404. If no operation has been detected, the process waits until an operation is detected.

If it is found in step S1402, for example, that an operation for displaying a user list has been performed, in step S1404, the user list is displayed.

In step S1406, it is judged whether one of the users in the list has been selected. If one of the users has been selected, the process proceeds to step S1408. If no user has been selected, the process waits until a user is selected.

In step S1408, the user ID of the selected user is identified.

In step S1410, the side of the shared screen on which the operation has been performed is determined.

In step S1412, the user position management table 700 which associates the side of the shared screen and the user 480 with each other is generated.

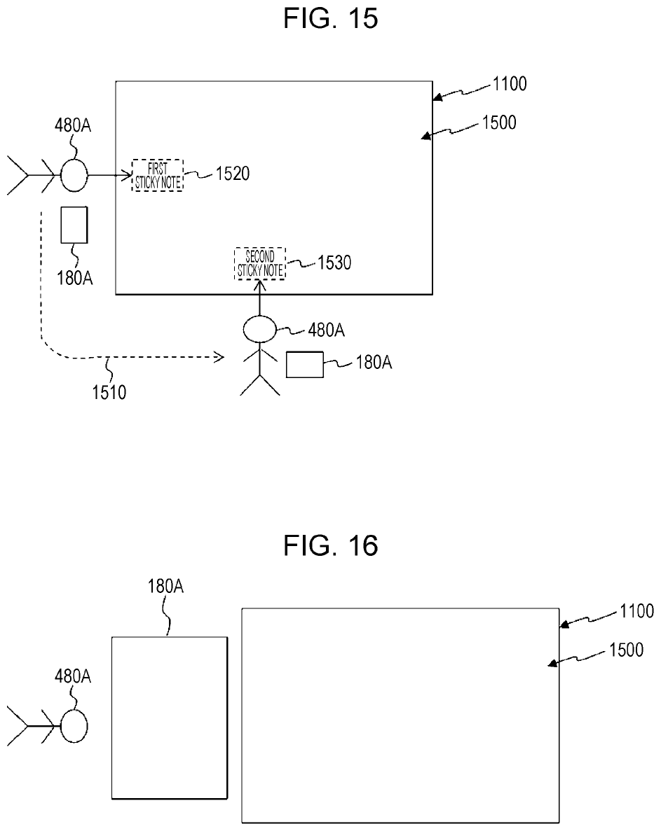

FIG. 15 illustrates an example of processing executed by the exemplary embodiment.

By using the information processing apparatus 100 of the exemplary embodiment, a user is able to add sticky notes to the board by changing the position of the user.

A board 1500 is displayed on the shared screen 1100. The user 480A holding the user terminal 180A is located near the left side of the board 1500. The user 480A creates a first sticky note 1520 by operating the user terminal 180A and adds it to the board 1500. The user 480A then moves to the vicinity of the bottom side of the board 1500, as indicated by an arrow 1510 in FIG. 15, where the user 480A creates a second sticky note 1530 by operating the user terminal 180A and adds it to the board 1500.

Processing using provisional sticky notes will be described below in detail with reference to the examples in FIGS. 16 through 20.

FIG. 16 illustrates an example of processing executed by the exemplary embodiment.

The information processing apparatus 100 estimates the position of the user 480A from the sensor of the user terminal 180A of the user 480A, and determines a position of a sticky note to be placed on the board 1500 (also called a bubble position) for the user 480A. The position of a sticky note to be placed on the board 1500 is an area near the left side of the board 1500.

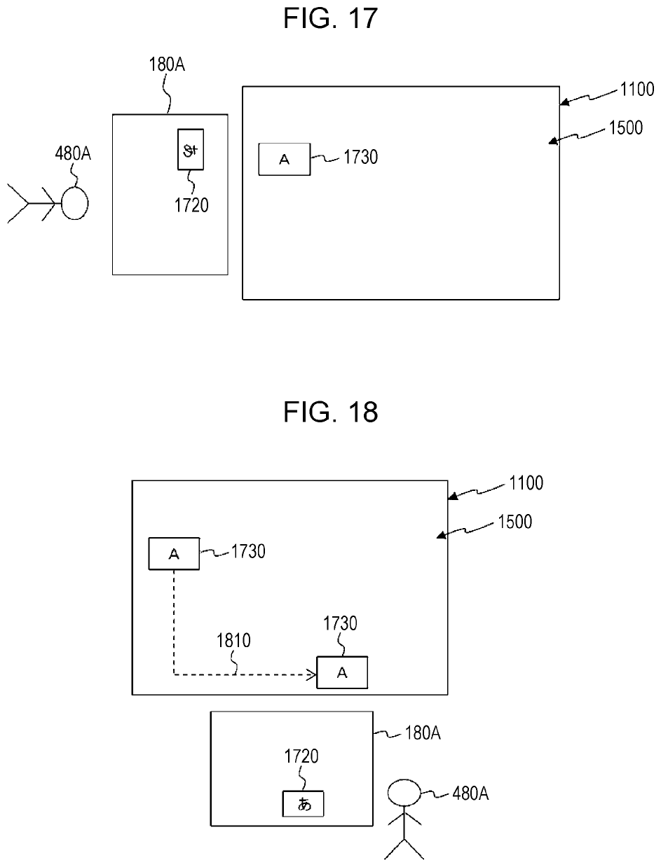

FIG. 17 illustrates an example of processing executed by the exemplary embodiment.

The user 480A operates the user terminal 180A and creates a sticky note 1720. Upon detecting that the sticky note 1720 has been created, the information processing apparatus 100 displays a provisional sticky note 1730 at a position at which a sticky note will be placed on the board 1500. At this stage, the information processing apparatus 100 only suggests the presence of a sticky note of the user 480A by using the provisional sticky note 1730 and does not allow any user to move the provisional sticky note 1730. For example, the information processing apparatus 100 indicates the name of the user 480A within the provisional sticky note 1730 and does not accept any operation on the provisional sticky note 1730 on the board 1500. Because of the presence of the provisional sticky note 1730, another user 480 understands that the user 480A has created a sticky note, but does not know its content and is also unable to perform any operation on the provisional sticky note 1730.

FIG. 18 illustrates an example of processing executed by the exemplary embodiment.

The user 480A moves from the left side to the bottom side of the shared screen 1100. The position of the sticky note to be placed on the board 1500 for the user 480A is also changed in accordance with the movement of the user 480A. As a result, the provisional sticky note 1730 is moved to the bottom side, as indicated by an arrow 1810 in FIG. 18. If the user 480A performs a predetermined operation (operation for determining the position of the sticky note 1720), the position of the sticky note is fixed.

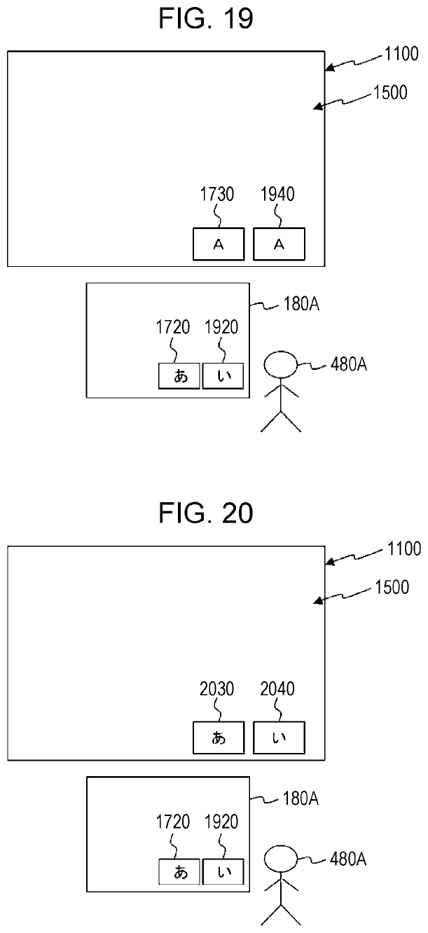

FIG. 19 illustrates an example of processing executed by the exemplary embodiment.

When the user 480A has also created a sticky note 1920, the information processing apparatus 100 displays a provisional sticky note 1940 in an area where a sticky note will be placed on the board 1500. The information processing apparatus 100 indicates the name of the user 480A within the provisional sticky note 1940 and does not accept any operation on the provisional sticky note 1940 on the board 1500, as in the provisional sticky note 1730.

FIG. 20 illustrates an example of processing executed by the exemplary embodiment.

When the user 480A operates the user terminal 180A and sends the sticky notes 1720 and 1920 to the information processing apparatus 100 (for the user 480A, it would be like sending the sticky notes 1720 and 1920 to the board 1500), the provisional sticky notes 1730 and 1940 are changed to sticky notes 2030 and 2040, respectively. That is, the same content of the sticky note 1720 is displayed on the sticky note 2030, and the same content of the sticky note 1920 is displayed on the sticky note 2040. In other words, the sticky notes 2030 and 2040 of the user 480A are opened to the other users. The sticky notes 2030 and 2040 are now available to be moved on the board 1500.

If, at the stage in the example in FIG. 17, the user 480A sends the sticky note 1720 to the information processing apparatus 100, the provisional sticky note 1730 is changed to the sticky note 2030. Then, even if the user 480A moves, as in the example in FIG. 18, the sticky note 2030 does not move in accordance with the movement of the user 480A. Once the sticky note 1720 is sent to the information processing apparatus 100, it no longer belongs only to the user 480A, and another user is able to perform an operation on the sticky note 2030, such as moving it on the board 1500.

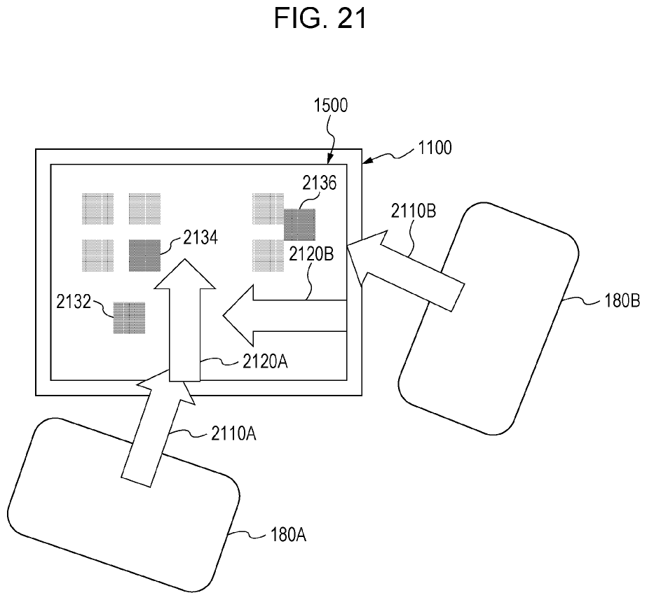

Approaches to detecting a user terminal 180 or a user 480 will be discussed below with reference to FIGS. 21 through 23.

FIG. 21 illustrates an example of processing executed by the exemplary embodiment, and this processing corresponds to processing in the flowchart of FIG. 10.

The board 1500 is displayed on the shared screen 1100, and sticky notes such as a sticky note 2132 have been added to the board 1500.

It is judged from a sensor, such as an acceleration sensor or a direction sensor, within the user terminal 180, which side of the board 1500 will be used most suitably as the top side of the board 1500.

For example, the user terminal 180A identifies a terminal direction 2110A by using an acceleration sensor or a direction sensor, and sends information concerning the terminal direction 2110A to the information processing apparatus 100. The information processing apparatus 100 determines, based on the information concerning the terminal direction 2110A, that the direction from the bottom side to the top side of the board 1500 is an upward direction 2120A of the shared screen 1100 as viewed from the user terminal 180A. The user terminal 180B identifies a terminal direction 2110B by using an acceleration sensor or a direction sensor, and sends information concerning the terminal direction 2110B to the information processing apparatus 100. The information processing apparatus 100 determines, based on the information concerning the terminal direction 2110B, that the direction from the right side to the left side of the board 1500 is an upward direction 2120B of the shared screen 1100 as viewed from the user terminal 180B.

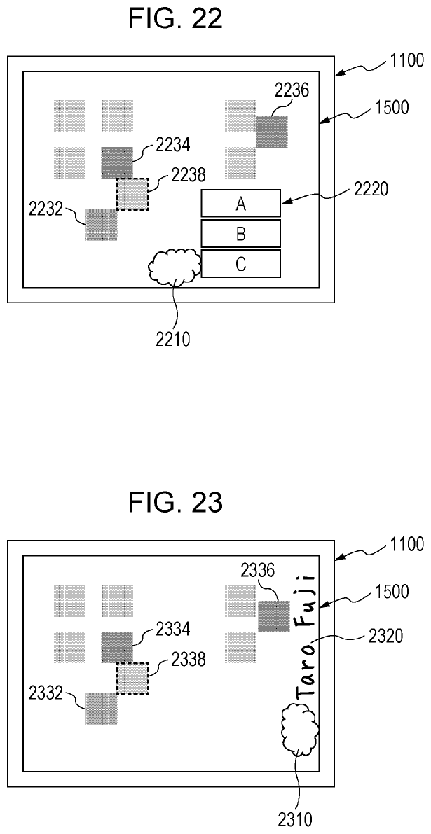

FIG. 22 illustrates an example of processing executed by the exemplary embodiment, and this processing corresponds to processing in the flowchart of FIG. 14. The position of a sticky note to be placed on the board 1500 is determined by the operation performed by the user 480 on the board 1500.

The board 1500 is displayed on the shared screen 1100, and sticky notes such as a sticky note 2232 have been added to the board 1500.

When a double-tapping operation by the user 480 on the vicinity of the bottom side of the board 1500 is detected, a list of all users is displayed, and the user 480 chooses the name of the user 480 from the list. Then, the user 480 (user ID) and the bottom side of the board 1500 are associated with each other.

More specifically, when the user 480 double-taps a certain position on the board 1500, a user detection position 2210 and a user list 2220 are displayed around the double-tapped position. When the name of the user 480 is selected, the double-tapped position is set as the position of a sticky note to be placed on the board 1500 for the user 480.

FIG. 23 illustrates an example of processing executed by the exemplary embodiment, and this processing corresponds to processing in the flowchart of FIG. 13. The position of a sticky note to be placed on the board 1500 is determined by a handwritten name of the user 480 on the board 1500.

The board 1500 is displayed on the shared screen 1100, and sticky notes such as a sticky note 2332 have been added to the board 1500.

When the user 480 has written its name in longhand with a finger or a pen (handwritten user name 2320 “Taro Fuji” in FIG. 23), a user detection position 2310 is displayed, and the handwritten user name 2320 is recognized by character recognition. The position of the recognized handwritten characters is set as the position of a sticky note to be placed on the board 1500 for the user 480.

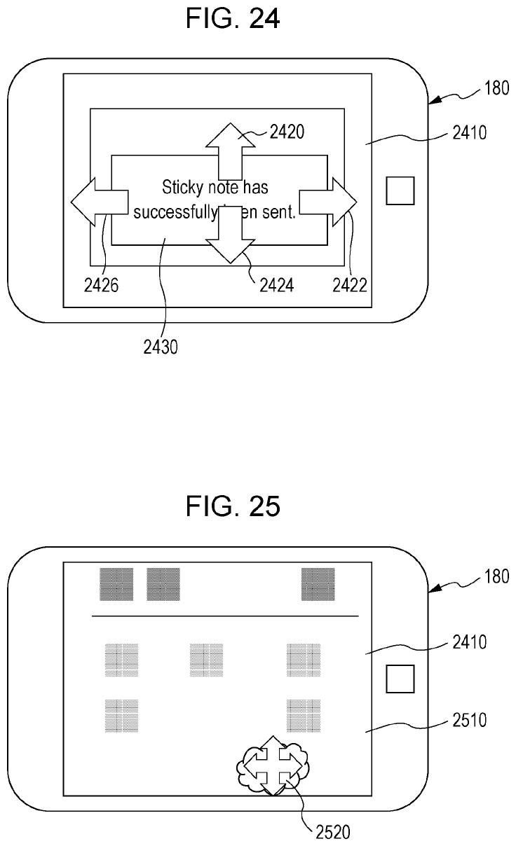

Processing for determining the position of a sticky note as a result of the user 480 performing an operation on the user terminal 180 will be described below with reference to FIGS. 24 and 25.

FIG. 24 illustrates an example of processing executed by the exemplary embodiment. The user 480 selects a position of a sticky note by performing an operation on the user terminal 180 when sending the sticky note.

After a sticky note is created, sending direction instructing buttons 2420, 2422, 2424, and 2426, which are each an arrow indicating a direction within the board, are displayed on a terminal screen 2410 of the user terminal 180. The user 480 selects one of the sending direction instructing buttons 2420 through 2426. If the user 480 selects the sending direction instructing button 2420, the area near the top side of the board is set as the position of a sticky note. If the user 480 selects the sending direction instructing button 2422, the area near the right side of the board is set as the position of a sticky note. If the user 480 selects the sending direction instructing button 2424, the area near the bottom side of the board is set as the position of a sticky note. If the user 480 selects the sending direction instructing button 2426, the area near the left side of the board is set as the position of a sticky note.

In a message display area 2430, a message, such as “Sticky note has successfully been sent”, is displayed.

FIG. 25 illustrates an example of processing executed by the exemplary embodiment.

A board 2510 is displayed on the terminal screen 2410 of the user terminal 180, and the position of a sticky note is determined as a result of the user 480 moving a sticky-note-position determining object 2520 on the board 2510. For example, if the user 480 has moved the sticky-note-position determining object 2520 to the bottom side of the board 2510, the area near the bottom side is selected as the position of a sticky note.

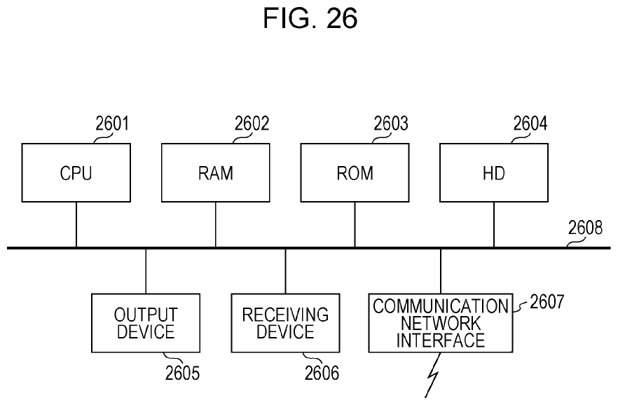

The hardware configuration of a computer in which a program serving as the exemplary embodiment is executed is the configuration of a general computer, such as a PC or a server, as shown in FIG. 26. More specifically, such a computer uses a CPU 2601 as a processor (operation unit) and a RAM 2602, a read only memory (ROM) 2603, and a hard disk (HD) 2604 as storage devices. As the HD 2604, a hard disk or a solid state drive (SSD), which is a flash memory, may be used. The computer includes the CPU 2601, the RAM 2602, the ROM 2603, the HD 2604, an output device 2605, a receiving device 2606, a communication network interface 2607, and a bus 2608. The CPU 2601 executes a program, such as the communication module 105, the sticky-note-position determining module 110, the user detecting module 115, the user operation obtaining module 120, the user terminal detecting module 125, the user terminal operation obtaining module 130, the position determining module 135, the board/sticky-note managing module 140, the display control module 145, the control module 165, the display device 170, the communication module 175, the control module 185, the display device 190, and the communication module 195. The RAM 2602 stores this program and data therein. The ROM 2603 stores a program for starting the computer. The HD 2604 is an auxiliary storage device storing the terminal-user management table 500, the user management table 600, the user position management table 700, the board information table 800, and the sticky-note information table 900. Examples of the output device 2605 are a cathode ray tube (CRT), a liquid crystal display, and a speaker. The receiving device 2606 receives data based on an operation (including motion, sound, and gaze) performed by a user on a keyboard, a mouse, a touchscreen, a microphone, or a camera (including a gaze detection camera). The communication network interface 2607 is, for example, a network interface card, for communicating with a communication network. The above-described elements are connected to one another via the bus 2608 and send and receive data to and from one another. The above-described computer may be connected to another computer configured similarly to this computer via a network.

In the above-described exemplary embodiment, concerning elements implemented by a software computer program, such a computer program is read into a system having the hardware configuration shown in FIG. 26, and the above-described exemplary embodiment is implemented by a combination of software and hardware resources.

The hardware configuration shown in FIG. 26 is only an example, and the exemplary embodiment may be configured in any manner in which the modules described in the exemplary embodiment are executable. For example, some modules may be configured as dedicated hardware (for example, an application specific integrated circuit (ASIC)), or some modules may be installed in an external system and be connected to the PC via a communication line. A system, such as that shown in FIG. 26, may be connected to a system, such as that shown in FIG. 26, via a communication line, and may be operated in cooperation with each other. Additionally, instead of into a PC, the modules may be integrated into a mobile information communication device (including a cellular phone, a smartphone, a mobile device, and a wearable computer), a home information appliance, a robot, a copying machine, a fax machine, a scanner, a printer, or a multifunction device (image processing apparatus including two or more functions among a scanner, a printer, a copying machine, and a fax machine).

The above-described program may be stored in a recording medium and be provided. The program recorded on a recording medium may be provided via a communication medium. In this case, the above-described program may be implemented as a “non-transitory computer readable medium storing the program therein” in the exemplary embodiment.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a CD read only memory (CD-ROM), a CD recordable (CD-R), and a CD rewritable (CD-RW), Blu-ray (registered trademark) disc, a magneto-optical disk (MO), a flexible disk (FD), magnetic tape, a hard disk, a ROM, an electrically erasable programmable read only memory (EEPROM) (registered trademark), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be the entirety or part of another program, or may be recorded, together with another program, on a recording medium. The program may be divided and recorded on plural recording media. Further, the program may be recorded in any form, for example, it may be compressed or encrypted, as long as it can be reconstructed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a display controller that performs control to display a board and a sticky note on a horizontal screen; and
a determining unit that determines a position of a sticky note to be placed on the board in accordance with a position of a user or an operation performed by the user,
wherein the display controller performs control to display a sticky note received from a terminal of the user at the position determined by the determining unit.

2. The information processing apparatus according to claim 1, wherein the determining unit detects a position of the terminal of the user and determines the position of the sticky note to be placed on the board in accordance with the position of the terminal.

3. The information processing apparatus according to claim 2, wherein the determining unit also detects a position of a body or part of the body of the user and determines the position of the sticky note to be placed on the board in accordance with the position of the body or part of the body and the position of the terminal.

4. The information processing apparatus according to claim 1, wherein the determining unit determines the position of the sticky note to be placed on the board in accordance with an operation performed by the user on the board.

5. The information processing apparatus according to claim 4, wherein:
the operation performed by the user is writing a name of the user in longhand; and
the determining unit recognizes the name of the user as a result of performing character recognition and determines the position of the sticky note to be placed on the board.

6. The information processing apparatus according to claim 4, further comprising:
a display that displays a list of user names, wherein
the operation performed by the user is selecting a name of the user from the list, and
the determining unit determines the position of the sticky note to be placed on the board in accordance with the selected name.

7. The information processing apparatus according to claim 1, wherein the determining unit determines the position of the sticky note to be placed on the board in accordance with an operation performed by the user on the terminal of the user.

8. The information processing apparatus according to claim 7, wherein the operation performed by the user is an operation when sending the sticky note from the terminal of the user.

9. The information processing apparatus according to claim 7, wherein the operation performed by the user is an operation on a board displayed on the terminal of the user.

10. The information processing apparatus according to claim 1, wherein the display controller displays a provisional sticky note at the position determined by the determining unit and moves the provisional sticky note on the board in accordance with movement of the user, the provisional sticky note being a drawing without content of the sticky note.

11. The information processing apparatus according to claim 1, wherein the display controller displays a provisional sticky note at the position determined by the determining unit, and does not accept any operation for moving the provisional sticky note on the board, and after the provisional sticky note is converted into a sticky note, the display controller accepts an operation for moving the provisional sticky note on the board, the provisional sticky note being a drawing without content of the sticky note.

12. A non-transitory computer readable medium storing a program causing a computer to execute a process, the process comprising:
performing control to display a board and a sticky note on a horizontal screen; and
determining a position of a sticky note to be placed on the board in accordance with a position of a user or an operation performed by the user,
wherein a sticky note received from a terminal of the user is displayed at the determined position.

13. An information processing apparatus comprising:
display control means for performing control to display a board and a sticky note on a horizontal screen; and
determining means for determining a position of a sticky note to be placed on the board in accordance with a position of a user or an operation performed by the user,
wherein the display control means performs control to display a sticky note received from a terminal of the user at the position determined by the determining means.
